(19) United States
(12) Patent Application Publication
(10) Pub. No.: US 2009/0297682 A1
(43) Pub. Date: Dec. 3, 2009

(54) CEREAL-BASE FOOD PREPARATION, CONSISTING MAINLY OF OAT BRAN, FOR THE INDUSTRIAL MANUFACTURE OF FOOD PRODUCTS

(76) Inventor: Pierre Dukan, Paris (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/347,007

(22) Filed: Dec. 31, 2008

(30) Foreign Application Priority Data
Jun. 2, 2008 (FR) FR0803011
Jul. 9, 2008 (FR) FR0803909

(51) Int. Cl. A23L 1/10; A23L 1/05; A23L 1/0524; A21D 13/08; A21D 10/04

(52) U.S. Cl. 426/552; 426/618; 426/627; 426/573; 426/576; 426/577; 426/556

(57) ABSTRACT

The invention concerns a cereal-base food preparation for the industrial manufacture of food products.

The invention consists in that the cereals contain oat bran to the extent of at least 85% of the total cereal content and are mixed with at least one fluid component, whose content and time of impregnation of said cereals are chosen to produce a fluid semisaturation of the oat bran fibers and further containing at least one agent that promotes caking of the preparation on baking.

Application to food products such as pancakes, crepes, blinis and the like.

The present invention concerns a cereal-base food preparation, consisting mainly of oat bran, for the industrial production of food products such as pancakes, crepes and blinis, as well as a method of manufacture of food products such as pancakes, crepes and blinis using such a food preparation.

Oat bran represents the outer fibrous coating of the oat and, constituting the poor part of that cereal, it has often been used as animal feed as well as for making mattresses.

Since the 1950s, it has been realized that flavorless vegetable fibers unassimilable by the human organism have physiological properties capable of playing a new role in prevention of the risk factors caused by lifestyles of abundance.

Thus, cardiologists have demonstrated the value of oat bran in lowering blood cholesterol levels thanks to the presence of soluble fibers like beta-glucanes. Diabetologists have clearly established that oat bran reduces the rate of assimilation of fast sugars and thereby lowers the glycemic and insulinic peaks which weaken the pancreas. Gastroenterologists know that oat bran regulates intestinal transit, and cancerologists have proven that fiber generally reduces the frequency of colon cancer, the leading male cancer among regular consumers of bran and of oat bran fiber in particular, which are far less an irritant than the other fibers.

Finally, nutritionists discovered that oat bran, under certain conditions of milling, texture, hydration and baking method, type and time, can create a calorie loss of the gastric contents, resulting in a reduction of food intake, which is extremely valuable in the struggle against obesity, ranked as the sixth scourge of mankind by the World Health Organization.

The home-made preparation of crepes, pancakes or blinis is familiar. The industrial use of all types of cereals is also well known, making use of a wheat base to permit baking. However, to date, it has never been proposed that a food product should be manufactured industrially with oat bran as the sole vegetable ingredient, without the addition of wheat and prepared fat-free as well.

In fact, the extremely absorbent vegetable texture of oat bran blocks the injection circuits of industrial pastes. In addition, oat bran lacks the consistency and elasticity necessary for those preparations to be cooked and produced on baking mats and turned over for bilateral baking.

Furthermore, the addition of any type of fatty substance like egg yolk and especially insufficient or excessive hydration lead to a loss of the medicinal properties accounting for its specificity and importance.

To overcome these problems, the present invention therefore proposes a food preparation such as a paste for the industrial production of food products like pancakes, crepes and blinis with a cereal base consisting mainly of oat bran, enabling those food products to be manufactured guaranteeing the flavors and medicinal properties of the beta-glucane molecules found in oat bran, while making industrial application thereof possible in observing the constraints of industrial manufacture.

The object of the invention is thus a cereal-base food preparation for the manufacture of food products, characterized in that the cereals contain oat bran to the extent of at least 85% of the total cereal content and are mixed with at least one fluid component, whose content and time of impregnation of said cereals are chosen to produce a fluid semisaturation of the oat bran fibers and further containing at least one agent that promotes caking of the preparation on baking.

A preparation containing cereals consisting mainly of oat bran is thus advantageously proposed, the oat bran content of which represents at least 85% of the total cereal content. The preparation can thus include other cereals like wheat, barley, spelt, etc., alone or mixed, which do not exceed 15% of the total cereal content.

The preparation can preferably solely contain oat bran as cereal. Such a preparation is particularly suitable for consumers suffering from gluten allergy, since the cereals consist solely of oat bran.

Furthermore, in the preparation according to the invention, the fluid component such as water, but also a fluid dairy product, makes controlled impregnation of the oat bran possible, notably fixing the weight and volume of the preparation which will then be usable on a production line without the viscosity of the paste thus obtained standing in the way of its use in an industrial installation.

The oat bran is milled in such a way that the oat bran flakes are neither too fine nor too coarse. This so-called presoaking milling guarantees the effect of absorption and adhesiveness of the fibers responsible for sought-after calorie loss and reduction of intestinal gastric contents.

The fluid component is preferably water or a dairy product such as milk or white cheese.

The agent promoting caking of the preparation on baking is preferably an irreversible high-temperature gelling agent chosen in the group of gels formed by egg white, vegetable protein isolates or concentrates, and dairy proteins, particularly caseinates and their derivatives, taken individually or in combination.

A low-fat egg white is preferably used.

One can also envisage a high-temperature gelling agent of reversible type, chosen preferably in the group formed by methylcelluloses and their derivatives.

A low-temperature gelling agent can also be used, chosen in the group of gels formed by seaweed extracts, particularly carrageenans, gums such as agar agar, bean flour, pectins, gelatin and their derivatives, taken individually or in combination.

Among the gums, agar agar will be chosen as agent promoting satiation for consumers, which further improves the dietetic properties of the product desired for manufacture. Agar agar is thus preferably added in a proportion between 1 and 1.25% of the oat bran content, which makes it possible to potentiate the medicinal effects sought-after without resulting in a loss of consistency in taste and excessive gellification of the preparation, which would prevent its use in an industrial production installation.

The preparation according to the invention can also contain flavoring agents such as sweeteners, natural or artificial aromas, herbs or spices.

The sweeteners are thus chosen among those whose sweetening power withstands baking, such as aspartame, saccharin, cyclamate, sucralose and polyols.

Vanilla, defatted cocoa, etc. can be used as natural aroma.

The preparation can also contain an agent with emulsifying and binding capacity, such as egg yolk, whose content in the mixture is chosen so that the cholesterol intake remains within the limits accessible to any consumer.

The preparation can preferably contain linseeds or any other element originating from flax as elements rich in omega 3, the seeds being usable whole or ground.

The preparation according to the invention can further contain any agent that would be necessary and commonly known per se, such as yeasts, for example.

The invention also advantageously concerns a method of manufacture of food products in cake form such as pancakes, crepes or blinis, characterized in that it comprises the stages of manufacture of a cereal-base preparation consisting of oat bran whose content represents at least 85% of the total cereal content, consisting of: mixing the cereals with at least one fluid component for impregnation of said cereals with said fluid component and at least one agent promoting caking of the preparation on baking, the content and impregnation time being chosen to produce a fluid semisaturation of the oat bran fibers, and then the stages consisting of depositing said preparation on a baking surface and baking said preparation on at least one side.

The preparation advantageously comes in the form of a paste and is deposited in pieces of the desired shape and size in order to constitute food products such as pancakes, crepes, blinis, pie crusts or pizza crusts, breads and the like.

Alternatively, the preparation can be deposited in a strip for baking and can then be cut up to the desired shape and size.

The baking time is advantageously chosen to give the product (pancake, crepe, etc.) its consistency without denaturing by vitrification the beta-glucane molecules that provide it with its medicinal properties.

The baking temperature, notably the temperature of the cooking surfaces, for example, is advantageously chosen to permit sealing and surface smoothing for baking without fat added to the baking surfaces. Baking is preferably carried out on both sides.

Thanks to the preparation and method according to the invention, an oat bran-base food product is obtained, whose medicinal properties associated with the beta-glucane molecules have been preserved and optimized thanks to the judicious choice of milling of the oat bran, fixing the weight and volume of the preparation ready to bake at the cooking time and temperature of the baking surfaces, as well as to the choice of components used such as the sweetener and agar agar, dairy product, egg white and egg yolk content.

The invention will now be described in greater detail with reference to a working example in which a sweetened oat bran pancake is prepared with the desired medicinal properties of oat bran.

A mixture is thus prepared containing 30 g of seedless oat bran, 40 g of low-fat white cheese, one tablespoon of water or about 5 cc, an egg white, ⅓ of an egg yolk and between 1 and 0.5 g of agar agar in extra-fine ground flakes.

The absorption and solubilization time is 1 minute and 45 seconds at room temperature, which makes it possible to produce a fluid semisaturation (white cheese, water) of the oat bran fibers.

The paste is then used in the form of a cake, which is baked on each side for between 30 and 80 seconds, depending on the equipment, temperature and cooking time. The weight of such a cake is 110 g before baking and 97 g after baking.

The invention is not limited to the example described, but embraces all the variants defined in the dependent claims.

1. Cereal-base food preparation for the manufacture of food products, characterized in that the cereals contain oat bran to the extent of at least 85% of the total cereal content and are mixed with at least one fluid component, whose content and time of impregnation of said cereals are chosen to produce a fluid semisaturation of the oat bran fibers and further containing at least one agent that promotes caking of the preparation on baking.

2. Food preparation according to claim 1, characterized in that the cereals solely consist of oat bran.

3. Food preparation according to claim 1, characterized in that the fluid component is water or a dairy product such as milk or white cheese.

4. Food product according to claim 1, characterized in that the agent promoting caking of the preparation on baking is an irreversible high-temperature gelling agent chosen in the group of gels formed by egg white, vegetable protein isolates or concentrates, and dairy proteins, particularly caseinates and their derivatives, taken individually or in combination.

5. Food preparation according to claim 1, characterized in that the agent promoting caking of the preparation on baking is a high-temperature gelling agent of reversible type, chosen preferably in the group formed by methylcelluloses and their derivatives.

6. Food preparation according to claim 1, characterized in that the agent promoting caking of the preparation on baking is a low-temperature gelling agent chosen in the group of gels formed by seaweed extracts, particularly carrageenans, gums such as agar agar, bean flour, pectins, gelatin and their derivatives, taken individually or in combination.

7. Food preparation according to claim 6, characterized in that the agar agar content is between 1 and 1.25% of the oat bran proportion.

8. Food preparation according to claim 1, characterized in that it contains flavoring agents such as sweeteners and natural or artificial aromas such as vanilla, defatted cocoa, herbs or spices.

9. Food preparation according to claim 8, characterized in that the sweeteners are chosen from among those whose sweetening power withstands baking, such as aspartame, saccharin, cyclamate, sucralose or polyols.

10. Food preparation according to claim 1, characterized in that the preparation contains linseeds or any other element originating from flax as elements rich in omega 3, the seeds being usable whole or ground.

11. Method of manufacture of food products in cake form such as pancakes, crepes, blinis, pie crusts or pizza crusts, breads and the like, comprising the steps of:
(a) manufacturing a cereal-base preparation having an oat bran content of at least 85% of a total cereal content;
(b) mixing the cereal-base preparation with at least one fluid component and at least one agent promoting caking on baking for impregnation of the cereal-base preparation with the fluid component and agent, wherein the impregnation time is chosen to produce a fluid semisaturation of oat bran fibers; and
(c) depositing the cereal-base preparation on a baking surface and baking the cereal-base preparation on at least one side.

12. Method according to claim 11, characterized in that the preparation is deposited on a strip for baking and is then cut up to the desired shape and size.

13. Method according to claim 11, characterized in that the preparation is deposited for baking in pieces of the desired shape and size.

14. Method according to claim 11, characterized in that a baking time is chosen to give the product a desired consistency without denaturing the beta-glucane molecules by vitrification.

15. Method according to claim 11, characterized in that a baking temperature of the cooking surfaces is chosen to permit sealing and surface smoothing for baking without adding fat to the baking surfaces, preferably on both sides.

16. A food product such as pancakes, crepes, blinis, pie crusts or pizza crusts or breads, comprising:
(a) a cereal-base having an oat bran content of at least 85% of a total cereal content; and
(b) at least one fluid component and at least one agent that promotes caking upon baking, wherein the fluid component and agent impregnate the cereal-base to produce a fluid semisaturation of fibers of the oat bran.

17. The food product according to claim 16, wherein the agent promoting caking on baking is a gelling agent chosen from the group consisting of gels formed by egg white, vegetable protein isolates or concentrates, dairy proteins such as caseinates and their derivatives, methylcelluloses and their derivatives, seaweed extracts, gums, bean flour, pectins, and gelatin and their derivatives, taken individually or in combination.

18. The food product according to claim 16, wherein the food product contains flavoring agents such as sweeteners and natural or artificial aromas such as vanilla, defatted cocoa, herbs or spices.

19. The food product according to claim 16, wherein the food product contains elements rich in omega 3, the elements being usable whole or ground.

20. The food product according to claim 16, wherein the food product is baked at a baking temperature sufficient to promote sealing and smoothing of a cooking surface without adding fat to the baking surfaces and at a baking time sufficient to give the food product a desired consistency without denaturing beta-glucane molecules by vitrification
